(19) United States
(12) Patent Application Publication
(10) Pub. No.: US 2016/0302147 A1
(43) Pub. Date: Oct. 13, 2016

(54) METHOD FOR COMMUNICATION BETWEEN TERMINAL AND BASE STATION IN MOBILE COMMUNICATION SYSTEM AND APPARATUS THEREFOR

(71) Applicant: Samsung Electronics Co., Ltd., Gyeonggi-do (KR)

(72) Inventor: Yong-Noh LEE, lncheon (KR)

(73) Assignee: Samsung Electronics Co., Ltd.

(21) Appl. No.: 15/095,755

(22) Filed: Apr. 11, 2016

(30) Foreign Application Priority Data
Apr. 9, 2015 (KR) 10-2015-0050473

(51) Int. Cl. H04W 52/02; H04W 76/04

(52) U.S. Cl. CPC H04W 52/0212; H04W 52/0229; H04W 76/048

(57) ABSTRACT

A method for communicating with a base station, by a terminal, in a mobile communication system is provided. The method includes receiving, from the base station, communication period-related information corresponding to a type of the terminal; determining at least one of a communication idle period and a communication duration based on the communication period-related information; transmitting, to the base station, information indicating at least one of the communication idle period and the communication duration; and communicating with the base station based on at least one of the communication idle period and the communication duration.

### PRIORITY

This application claims priority under 35 U.S.C. §119(a) to Korean Patent Application Serial No. 10-2015-0050473, which was filed in the Korean Intellectual Property Office on Apr. 9, 2015, the entire disclosure of which is incorporated herein by reference.

### BACKGROUND

1. Field of the Disclosure

The present disclosure relates generally to a mobile communication system, and more particularly, to an apparatus and method for communication between a mobile communication terminal and a base station providing reduced current consumption of a mobile communication terminal.

2. Description of the Related Art

In general, the mobile communication system has been developed to provide communication between users while ensuring the mobility of the users. Due to the rapid development of technology, the mobile communication system is capable of providing voice communication service and high-speed data communication services. In recent years, the next-generation mobile communication system has evolved into the human to machine (H2M) system and the machine to machine (M2M) system. To meet these needs, machine type communication (MTC) has been developed and supported in the 3^{rd} generation partnership project (3GPP) communication standard.

MTC has features different from those of existing mobile communication. The features may be classified depending on the usage of the MTC. For example, the MTC devices that require infrequent communication (a few times a day) regardless of the time may have ‘time tolerant’ features, and the MTC devices that are installed in one place to collect and transmit specific information without mobility requirements may have ‘low mobility’ features. Wireless operators may provide services in consideration of these unique features of MTC and the coexistence with existing mobile terminals.

In the 3GPP standard, a paging signal is periodically transmitted depending on the discontinuous reception (DRX) period that is set to one of 320 ms, 640 ms, 1,280 ms, and 2,560 ms regardless of the type and operational characteristics of the communication device, and the communication device performs a monitoring operation for a paging channel in every DRX period of the network, causing unnecessary power consumption in certain MTC devices.

However, the MTC device may receive the paging signal less frequently, compared with the normal mobile terminal. For example, if the device that is mainly aimed to transmit data to a server once a day by measuring the temperature (or other variable) of a particular area is set to wake up only during the transmission of the data, without the need to wake up in every DRX period, the current consumption may be considerably reduced. However, the DRX period cannot extend over a maximum of 2,560 ms due to the requirements of the 3GPP system. Therefore, there is a need for a scheme capable of performing communication only during the transmission of the data without interfering with the paging operation of the existing terminals.

### SUMMARY

An aspect of the present disclosure is to provide a method for communication between a terminal and a base station in a mobile communication system and an apparatus therefor, which reduce current consumption of the terminal while ensuring connectivity by setting a communication idle period (or wake period) corresponding to a type of terminal in the mobile communication system.

Another aspect of the present disclosure is to provide a method for communication between a terminal and a base station and an apparatus therefor, which reduce current consumption of a mobile communication terminal in a mobile communication system.

In accordance with an aspect of the present disclosure, a method for communicating with a base station by a terminal in a mobile communication system is provided. The method includes receiving communication period-related information corresponding to a type of terminal from the base station, determining at least one of a communication idle period and a communication duration based on the communication period-related information, and transmitting at least one of the determined communication idle period and communication duration to the base station, and performing communication with the base station depending on at least one of the determined communication idle period and communication duration.

In accordance with another aspect of the present disclosure, a terminal communicating with a base station in a mobile communication system is provided. The terminal includes a transceiver configured to receive communication period-related information corresponding to a type of terminal from the base station, and a controller configured to determine at least one of a communication idle period and a communication duration based on the communication period-related information, and control communication with the base station depending on at least one of the determined communication idle period and communication duration. The transceiver transmits at least one of the determined communication idle period and communication duration to the base station, and performs communication with the base station depending on at least one of the determined communication idle period and communication duration.

In accordance with another aspect of the present disclosure, a method for communicating with a terminal by a base station in a mobile communication system is provided. The method includes transmitting communication period-related information corresponding to a type of terminal to the terminal, receiving, from the terminal, at least one of a communication idle period and a communication duration determined based on the communication period-related information, and performing communication with the terminal depending on at least one of the determined communication idle period and communication duration.

In accordance with another aspect of the present disclosure, a base station communicating with a terminal in a mobile communication system is provided. The base station includes a transceiver configured to transmit communication period-related information corresponding to a type of terminal to the terminal, and receive, from the terminal, at least one of a communication idle period and a communication duration determined based on the communication period-related information, and a controller configured to control communication with the terminal depending on at least one of the determined communication idle period and communication duration. The transceiver performs communication with the terminal depending on at least one of the determined communication idle period and communication duration.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a mobile communication system according to an embodiment of the present disclosure;

FIG. 2 illustrates the structure of a radio protocol in a mobile communication system according to an embodiment of the present disclosure;

FIG. 3 illustrates a monitoring operation for a paging channel depending on a DRX period by a terminal in a mobile communication system according to an embodiment of the present disclosure;

FIG. 4 illustrates a monitoring operation for a paging channel by a terminal in a mobile communication system according to an embodiment of the present disclosure;

FIG. 5 is a flow diagram illustrating a communication process between a terminal and a base station according to an embodiment of the present disclosure;

FIG. 6 is a flow diagram illustrating a communication process between a terminal and a base station according to another embodiment of the present disclosure;

FIG. 7 is a flowchart illustrating a data transmission process of a terminal according to an embodiment of the present disclosure;

FIG. 8 is a flowchart illustrating a data reception process of a terminal according to various embodiments of the present disclosure;

FIG. 9 is a block diagram illustrating a configuration of a terminal in a mobile communication system according to an embodiment of the present disclosure;

FIG. 10 is a flowchart illustrating a data transmission process of a base station according to an embodiment of the present disclosure;

FIG. 11 is a flowchart illustrating a data reception process of a base station according to an embodiment of the present disclosure; and

FIG. 12 is a block diagram illustrating a configuration of a base station in a mobile communication system according to an embodiment of the present disclosure.

Throughout the drawings, like reference numerals will be understood to refer to like parts, components, and structures.

### DETAILED DESCRIPTION

Hereinafter, various embodiments of the present disclosure will be disclosed with reference to the accompanying drawings. However, the present disclosure is not limited to particular embodiments, rather it should be construed as including various modifications, equivalents, and/or alternatives according to the embodiments of the present disclosure. In describing the drawings, similar reference numerals refer to similar elements.

In the following description, a description of the technical details that are well known in the technical field belonging to the present disclosure and/or are not directly related to the present disclosure will be omitted.

In the present disclosure, expressions such as “having,” “may have,” “comprising,” or “may comprise” indicates the existence of a corresponding characteristic (such as an element, a numerical value, function, operation, or component) and does not exclude the existence of additional characteristics.

Expressions such as “A or B,” “at least one of A or/and B,” or “one or more of A or/and B” include all possible combinations of listed items. For example, “A or B,” “at least one of A and B,” or “one or more of A or B” indicate the entire of (1) including at least one A, (2) including at least one B, or (3) including both at least one A and at least one B.

Expressions such as “first,” “second,” “primarily,” or “secondary” may represent various elements regardless of order and/or importance and do not limit corresponding elements. The expressions may be used for distinguishing one element from another element. For example, a first user device and a second user device may represent different user devices regardless of order or importance. For example, a first element may be referred to as a second element without deviating from the scope of the present disclosure, and similarly, a second element may be referred to as a first element.

When it is described that an element (such as a first element) is “operatively or communicatively coupled” to or “connected” to another element (such as a second element), the element may be directly connected to the other element or may be connected to the other element through a third element. However, when it is described that an element (such as a first element) is “directly connected” or “directly coupled” to another element (such as a second element), it means that there is no intermediate element (such as a third element) between the element and the other element.

The expression “configured to (or set)” may be used interchangeably with, for example, “suitable for,” “having the capacity to,” “designed to,” “adapted to,” “made to,” or “capable of” according to context. The term “configured to (or set)” does not mean “specifically designed to” by hardware. Alternatively, in some situations, an expression “apparatus configured to” may mean that the apparatus “may” operate together with another apparatus or component. For example, the phrase “a processor configured (or set) to perform A, B, and C” may be a general-purpose processor (such as a CPU or an application processor) that may perform a corresponding operation by executing at least one software program stored at an exclusive processor (such as an embedded processor) for performing a corresponding operation or at a memory device.

In the present disclosure, the terms “terminal”, “user equipment”, “UE” and “mobile terminal” may be used interchangeably with one another.

Terms defined herein are used for describing a specific exemplary embodiment and may not limit the scope of other exemplary embodiments. When used in a description of the present disclosure and the appended claims, a singular form may include a plural form unless it is explicitly represented differently. Terms including technical terms and scientific terms used here may have the same meaning as generally understood by a person of common skill in the art. Terms defined in general dictionaries among terms used herein have the same meaning as or a meaning similar to that of a context of related technology and do not have an ideal or excessively formal meaning unless explicitly defined. In some case, terms defined in the present disclosure cannot be analyzed to exclude the present exemplary embodiments.

A user equipment (UE) or a terminal herein may include a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device. The wearable device may include an accessory-type wearable device (e.g., a watch, a ring, a bracelet, an anklet, a necklace, glasses, a contact lens, or a head mounted device (HMD)), a fabric/clothing-integrated wearable device (e.g., electronic clothing), a body-mounted wearable device (e.g., a skin pad or tattoo), or a bio-implantable wearable device (e.g., an implantable circuit).

The terminal may also be a home appliance. The home appliance may include a television (TV), a digital video disk (DVD) player, an audio player, a refrigerator, an air conditioner, a vacuum cleaner, an oven, a microwave oven, a washer, an air purifier, a set-top box, a home automation control panel, a security control panel, a TV box (e.g., a Samsung HomeSync™, an Apple TV™, or a Google TV™), a game console (e.g., Xbox™ or PlayStation™), an electronic dictionary, an electronic key, a camcorder or a digital photo frame.

The terminal may also include various medical devices (e.g., various portable medical meters (e.g., a blood glucose meter, a heart rate meter, a blood pressure meter, a temperature meter and the like), a magnetic resonance angiography (MRA) device, a magnetic resonance imaging (MRI) device, a computed tomography (CT) device, a medical camcorder, an ultrasonic device and the like), a navigation device, a global navigation satellite system (GNSS), an event data recorder (EDR), a flight data recorder (FDR), an automotive infotainment device, a marine electronic device (e.g., a marine navigation device, a gyro compass and the like), avionics, a security device, a car head unit, an industrial or household robot, an automatic teller machine (ATM), point of sales (POS) terminal, or an Internet of Things (IoT) device (e.g., an electric bulb, various sensors, an electricity or gas meter, a sprinkler device, a fire alarm, a thermostat, a streetlamp, a toaster, fitness equipment, a hot water tank, a heater, a boiler and the like).

The terminal may also include a part of furniture or a building/structure, an electronic board, an electronic signature receiving device, a projector, or various meters (e.g., meters for water, electricity, gas or radio waves).

The terminal may also be a flexible electronic device.

The terminal may be one or a combination of the above-described devices. Further, the terminal will not be limited to the above-described devices, and may include a new electronic device based on the development of new technology.

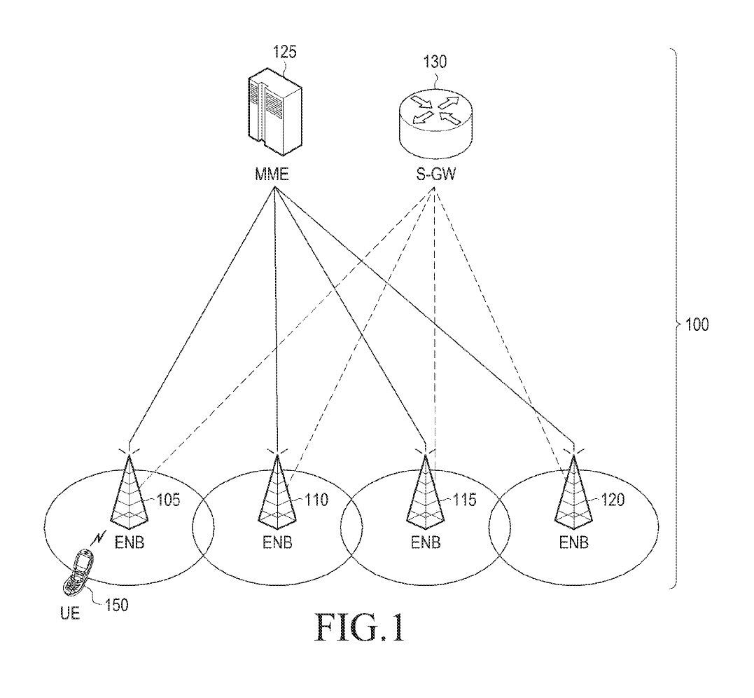

FIG. 1 illustrates a mobile communication system according to an embodiment of the present disclosure.

Referring to FIG. 1, a network 100 of the mobile communication system may include evolved node Bs (ENBs or base stations) 105, 110, 115 and 120, a mobility management entity (MME) 125, and a serving-gateway (S-GW) 130. A user equipment (UE) or a terminal 150 may access the network through the ENBs 105 to 120 and the S-GW 130.

In FIG. 1, the ENBs 105 to 120 may each correspond to the legacy node B in the universal mobile telecommunication system (UMTS) system. The ENBs 105 to 120 may each be connected to the terminal 150 by a wireless channel, and may perform a more complex role than the legacy node B. In the mobile communication system, since all user traffic including the real-time services such as voice over IP (VoIP) is serviced through the shared channel, there is a need for a device that collects and schedules the status information such as buffer status, available transmission power status and channel status of the terminal 150, and this role may be covered by each of the ENBs 105 to 120. One ENB may typically control a plurality of cells. In order to achieve the transfer rate of, for example, 100 Mbps or more, the mobile communication system may use orthogonal frequency division multiplexing (OFDM) as wireless access technology in the bandwidth of, for example, 20 MHz. Further, the adaptive modulation & coding (AMC) scheme for determining a modulation scheme and a channel coding rate depending on the channel status of the terminal 150 may be applied. The S-GW 130 is a device for providing a data bearer, and may generate or remove a data bearer under control of the MME 125. The MME 125 is a device responsible not only for the mobility management function for the terminal 150, but also for various control functions, and may be connected to a plurality of ENBs 105 to 120.

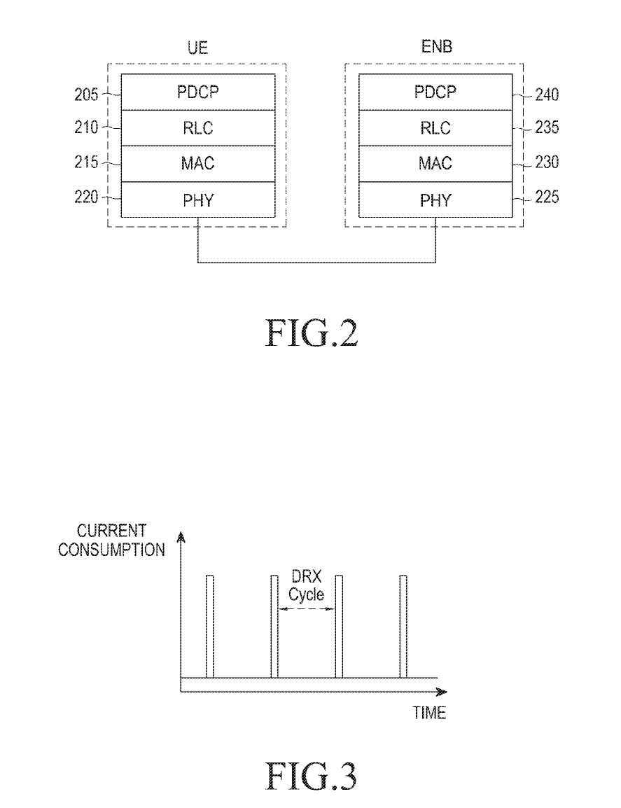

FIG. 2 illustrates the structure of a radio protocol in a mobile communication system according to an embodiment of the present disclosure.

Referring to FIG. 2, the radio protocol of the mobile communication system may include network layers including packet data convergence protocols (PDCPs) 205 and 240, radio link controls (RLCs) 210 and 235, medium access controls (MACs) 215 and 230 and physical layer (PHY) 220 and 225 in a terminal and an ENB. The PDCPs 205 and 240 are responsible for operations such as Internet protocol (IP) header compression/decompression, and the RLCs 210 and 235 may reconfigure a PDCP packet data unit (PDU) to an appropriate size. The MACs 215 and 230 are connected to several RLC layer devices configured in one terminal, and may perform an operation of multiplexing RLC PDUs into a MAC PDU and de-multiplexing RLC PDUs from a MAC PDU. Physical (PHY) layers 220 and 225 may perform an operation of channel-coding and modulating the upper layer data to make an OFDM symbol and transmit the OFDM symbol over a wireless channel, or may perform demodulating and channel-decoding on an OFDM symbol received over a wireless channel and transferring the decoded data to the upper layer. Further, as a control channel of the physical layer, a physical downlink control channel (PDCCH) may provide the terminal with resource allocation information for a paging channel (PCH) and a downlink shared channel (DL-SCH) and hybrid automatic repeat request (HARQ) information related to the DL-SCH. The PDCCH may include a scheduling grant that provides the terminal with resource allocation information for uplink transmission. Further, a physical control format indicator channel (PCFICH) may provide the terminal with information about the number of OFDM symbols used in PDCCHs, and may be transmitted in every sub-frame. Further, a physical uplink indicator channel (PHICH) may include uplink control information such as HARQ ACK/NACK, scheduling request and channel quality indicator (CQI) for downlink transmission. Further, a physical uplink shared channel (PUSCH) may include an uplink shared channel (UL-SCH).

FIG. 3 is a diagram illustrating a monitoring operation for a paging channel depending on a DRX period by a terminal in a general mobile communication system.

Referring to FIG. 3, in the general 3GPP mobile communication system, a terminal may perform discontinuous reception (DRX) in communicating with the network. The network may configure a paging channel depending on a set DRX period. The terminal may perform a monitoring operation for the paging channel in every DRX period by maintaining the communication function to ensure the real-time connectivity with the network. The terminal may consume current due to its maintaining of the communication function and the consumption of current for monitoring the paging channel by waking up in every DRX period.

System information may include the information that the terminal requires in order to access the network. Therefore, the terminal may receive all the system information before accessing the network, and may also have the latest system information at all times. Since the system information is the information that all UEs in a cell require, the network may transmit the system information periodically.

In the 3GPP mobile communication system, this system information may be configured with a master information block (MIB), a scheduling block (SB) and a system information block (SIB). The MIB may allow the terminal to know or determine the physical configuration (e.g., the bandwidth) of the cell. Further, the SB may include transmission information of SIBs (e.g., scheduling information of SIBs). Further, the SIB is an aggregate of system information related to each other. For example, some SIBs may include only the information about the adjacent cells, and some SIBs may include only the information about the uplink wireless channel used by the terminal.

Machine type communication (MTC) refers to communication that is made between machines without human intervention. AnLMTC service may be distinct from the service between humans. The MTC services may include the following service categories: tracking, metering, payment, healthcare, and remote control services.

In the case of a terminal supporting MTC, since its connection to the network is not required to follow the existing DRX period, the current consumption may be reduced dramatically if the terminal wakes up only during the data transmission.

An embodiment of the present disclosure includes a scheme capable of minimizing the current consumption of the terminal by applying the device class that is newly defined in the system information exchanged between the network and the terminal in the mobile communication system. The device class is obtained by defining communication period-related information corresponding to the type of terminal, and may include information indicating whether the network supports the communication scheme corresponding to the device class, and information specifying the communication idle period and communication duration corresponding to the type of the terminal. Here, the communication idle period may refer to the period in which the operation is switched from idle mode where the terminal waits in the low-power state, to the operation mode where the terminal wakes up, and the communication duration may refer to the time period for which the operation mode lasts.

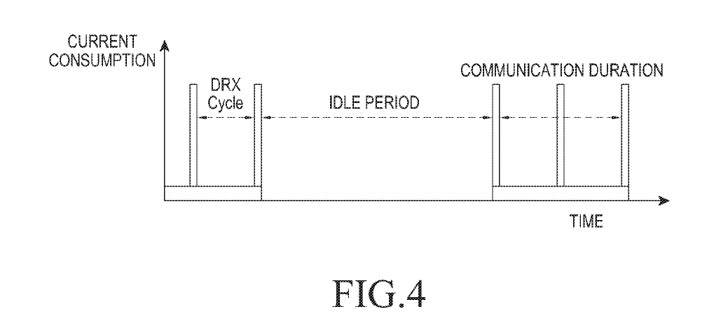

FIG. 4 is a diagram illustrating a monitoring operation for a paging channel by a terminal in a mobile communication system according to an embodiment of the present disclosure.

Referring to FIG. 4, a terminal may determine at least one of a communication idle period (or wake period) and a communication duration (or alive time) based on the communication period-related information received from the network, transmit information about the determined communication idle period and communication duration to the network, and perform communication with the network depending on the information about the determined communication idle period and communication duration.

As shown in FIG. 4, instead of performing the monitoring operation for the paging channel in every DRX period of the network, the terminal may monitor the paging channel corresponding to the DRX period beginning when the communication idle period expires, while maintaining the idle mode in which the terminal waits in the low-power state and the terminal does not operate the communication function in the communication idle period. This time may last for the communication duration. Since the terminal does not operate the communication function in the communication idle period, it is possible to reduce the current consumption of the UE by monitoring the paging channel and operating the communication function only when necessary. As a result, it is possible to reduce the current consumption of the terminal.

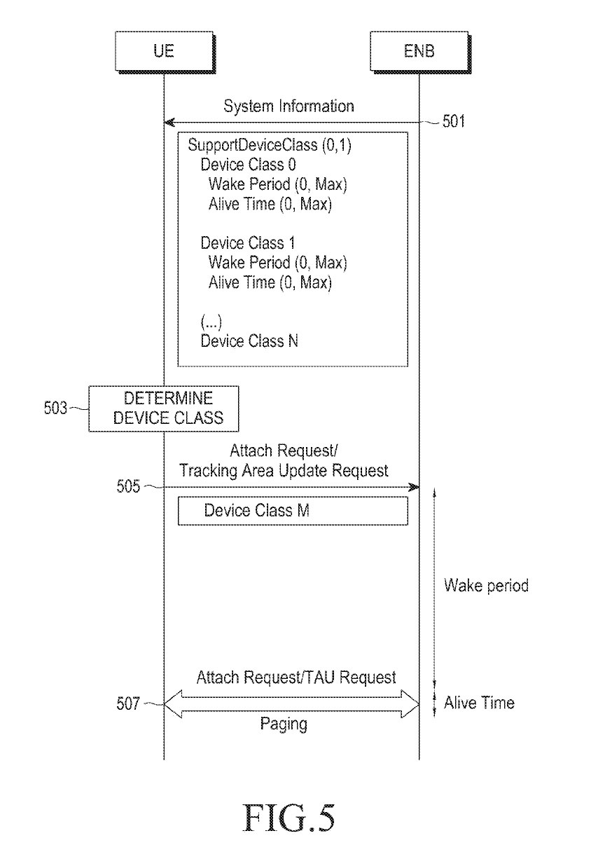

FIG. 5 is a flow diagram illustrating a communication process between a terminal and a base station according to an embodiment of the present disclosure.

In step 501, a terminal receives system information from an ENB. The system information may include the information that the terminal requires in order to access the ENB, and may be configured with a master information block (MIB), a scheduling block (SB) and a system information block (SIB). The MIB may allow the terminal to know or determine the physical configuration (e.g., the bandwidth) of the cell. Further, the SB may include transmission information of SIBs (e.g., scheduling information of SIBs). Further, the SIB is an aggregate of system information related to each other. For example, some SIBs may include only the information about the adjacent cells, and some SIBs may include only the information about the uplink wireless channel used by the terminal.

The system information may include the device class, for example, communication period-related information corresponding to the type of the terminal. The communication period-related information may include information indicating whether the ENB supports the communication scheme for allowing the terminal to determine a communication idle period and a communication duration depending on the type of terminal and perform communication depending on information about the determined communication idle period and communication duration. Further, the communication period-related information may include the information pre-specifying the communication idle period and the communication duration corresponding to the type of terminal, for example, the information for giving an index depending on the type of terminal and specifying the communication idle period and the communication duration corresponding to each index.

In step 503, the terminal determines the communication idle period and the communication duration based on the communication period-related information included in the received system information. The terminal may identify information indicating whether the ENB supports communication depending on the communication idle period and the communication duration corresponding to the type of terminal, which is included in the communication period-related information. If it is determined that the ENB supports communication, the terminal may determine the communication idle period and the communication duration corresponding to the terminal based on the information about the communication idle period and the communication duration corresponding to the type of terminal, which is included in the communication period-related information. The terminal may determine the communication idle period and the communication duration by selecting an index corresponding to the type of terminal from the communication period-related information.

In step 505, the terminal transmits information about the determined communication idle period and communication duration to the ENB. The terminal may transmit information about the determined communication idle period and communication duration to the ENB using an attach request message. The terminal may transmit information about the determined communication idle period and communication duration to the ENB using a tracking area update (TAU) request message. The ENB may transmit, to the terminal, an attach accept message or TAU accept message for acknowledging the attach request message or the TAU request message. Thereafter, the terminal and the ENB may perform communication depending on the determined communication idle period and communication duration.

In step 507, the terminal transmits the attach request message or the TAU request message depending on the determined communication idle and communication duration. Further, the ENB may also transmit the paging message depending on the determined communication idle period and communication duration.

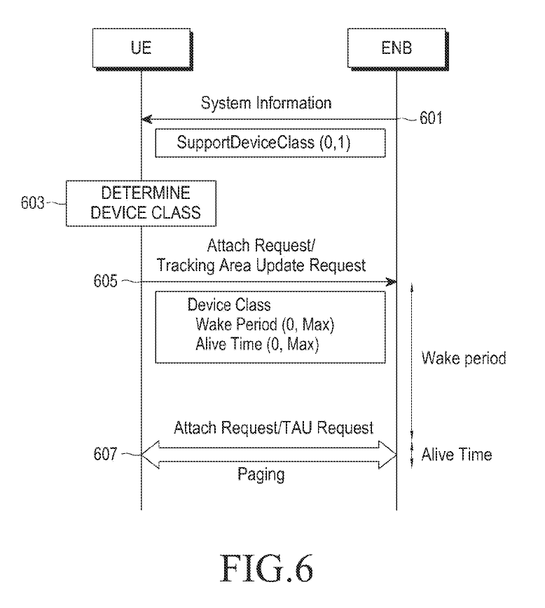

FIG. 6 is a flow diagram illustrating a communication process between a terminal and a base station according to another embodiment of the present disclosure.

In step 601, a terminal receives system information from an ENB. The system information may include communication period-related information. The communication period-related information may include only the information indicating whether the ENB supports the communication scheme for allowing the terminal to determine a communication idle period and a communication duration depending on the type of terminal and perform communication depending on the determined communication idle period and communication duration.

In step 603, the terminal determines the communication idle period and the communication duration based on the communication period-related information included in the received system information. The terminal may identify information indicating whether the ENB supports communication depending on the communication idle period and the communication duration corresponding to the type of terminal, which is included in the communication period-related information. If the ENB supports communication depending on the communication idle period and the communication duration corresponding to the type of terminal, the terminal may determine the communication idle period and the communication duration, which is predefined by the processor of the terminal, depending on the state of the terminal.

In step 605, the terminal transmits information about the determined communication idle period and communication duration to the ENB. The terminal may transmit information about the determined communication idle period and communication duration to the ENB using an attach request message. As another example, the terminal may transmit information about the determined communication idle period and communication duration to the ENB using a TAU request message. The ENB may transmit, to the terminal, an attach accept message or TAU accept message for acknowledging the attach request message or the TAU request message. Thereafter, the terminal and the ENB may perform communication depending on the determined communication idle period and communication duration.

In step 607, the terminal transmits the attach request message or the TAU request message depending on the determined communication idle and communication duration. Further, the ENB may also transmit the paging message depending on the determined communication idle period and communication duration.

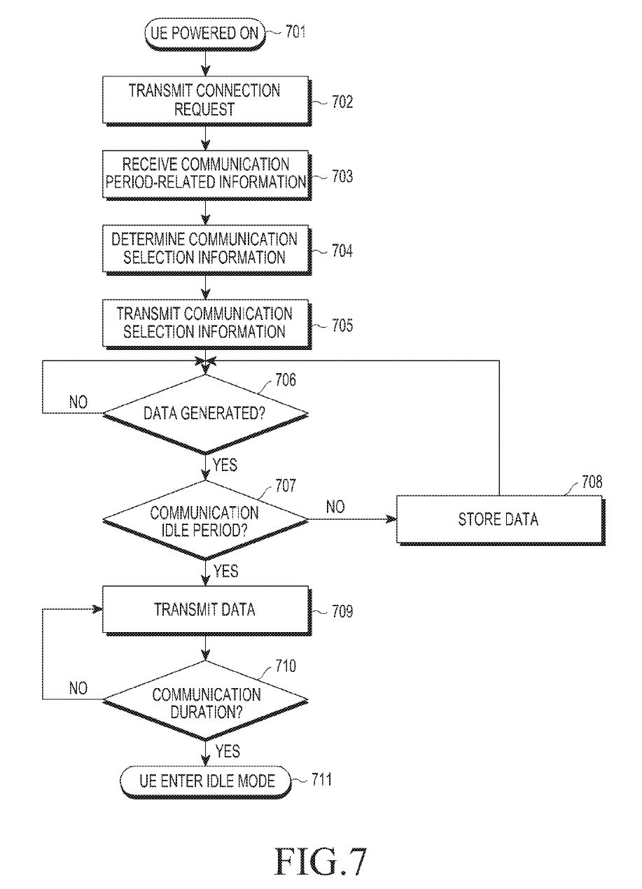

FIG. 7 is a flowchart illustrating a data transmission process of a terminal according to various embodiments of the present disclosure.

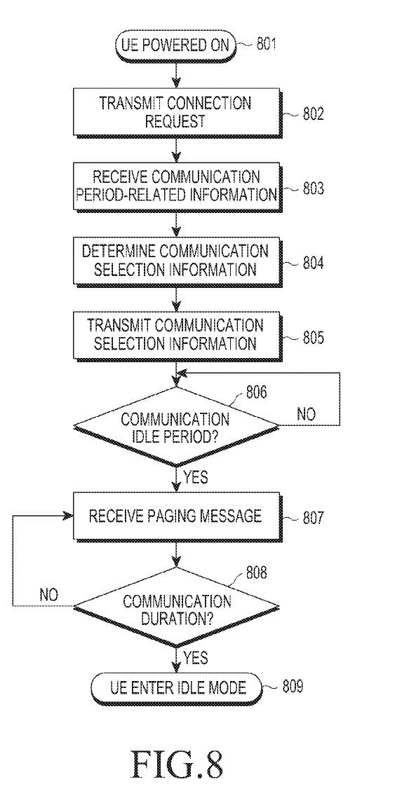

FIG. 8 is a flowchart illustrating a data reception process of a terminal according to various embodiments of the present disclosure.

A data transmission/reception process of a UE according to various embodiments of the present disclosure will be described in detail below with reference to FIGS. 7 and 8.

Referring to FIG. 7, in step 701, a terminal is powered on. In step 702, the terminal selects one ENB (or cell) by searching for a signal from an adjacent cell included in the ENB, and transmits a connection request to inform the ENB that the communication connection is now available as the terminal is powered on. For the connection request, a radio resource control (RRC) connection request message, which is one of the control messages of the RRC layer, may be used.

In step 703, the terminal receives system information from the ENB. The system information may include communication period-related information corresponding to the type of terminal. The communication period-related information may include information indicating whether the ENB supports the communication scheme for allowing the terminal to determine a communication idle period and a communication duration depending on the type of terminal and perform communication depending on the determined communication idle period and communication duration. Further, the communication period-related information may include the information pre-specifying the communication idle period and the communication duration corresponding to the type of terminal.

In step 704, the terminal determines the communication idle period and the communication duration based on the communication period-related information included in the received system information. The terminal may identify information indicating whether the ENB supports communication depending on the communication idle period and the communication duration corresponding to the type of terminal, which is included in the communication period-related information. If the ENB supports communication depending on the communication idle period and the communication duration corresponding to the type of terminal, the terminal may determine the communication idle period and the communication duration corresponding to the terminal based the communication idle period and the communication duration corresponding to the type of terminal, which is included in the communication period-related information.

In step 705, the terminal transmits information about the determined communication idle period and communication duration to the ENB. The terminal may transmit the information about the determined communication idle period and communication duration to the ENB using an attach request message. The terminal may also transmit the information about the determined communication idle period and communication duration to the ENB using a TAU request message.

In step 706, the terminal determines whether data to be transmitted through the ENB has been generated. If data has been generated, the terminal determines in step 707 whether the communication idle period determined in step 704 has arrived. If the communication idle period has not arrived, the terminal stores the generated data in step 708, and if the communication idle period has arrived, the terminal transmits the generated or stored data through communication with the ENB in step 709.

In step 710, the terminal maintains the communication with the ENB for the communication duration determined in step 704, and if the communication duration expires, the terminal enters the idle mode in step 711.

Referring to FIG. 8, in step 801, the terminal is powered on. In step 802, the terminal selects one ENB (or cell) by searching for a signal from an adjacent cell included in the ENB, and transmits a connection request to inform the ENB that the communication connection is now available as the terminal is powered on. For the connection request, an RRC connection request message, which is one of the control messages of the RRC layer, may be used.

In step 803, the terminal receives system information from the ENB. The system information may include communication period-related information corresponding to the type of terminal. The communication period-related information may include whether the ENB supports the communication scheme for allowing the terminal to determine a communication idle period and a communication duration depending on the type of terminal and perform communication depending the determined communication idle period and communication duration. Further, the communication period-related information may include the information pre-specifying the communication idle period and the communication duration corresponding to the type of terminal.

In step 804, the terminal determines the communication idle period and the communication duration based on the communication period-related information included in the received system information. The terminal may identify whether the ENB supports communication depending on the communication idle period and the communication duration corresponding to the type of terminal, which is included in the communication period-related information. If the ENB supports communication depending on the communication idle period and the communication duration corresponding to the type of terminal, the terminal may determine the communication idle period and the communication duration corresponding to the terminal based on the information included in the communication period-related information.

In step 805, the terminal transmits information about the determined communication idle period and communication duration to the ENB. The terminal may transmit the information about the determined communication idle period and communication duration to the ENB using an attach request message. The terminal may also transmit the information about the determined communication idle period and communication duration to the ENB using a TAU request message.

In step 806, the terminal determines whether the communication idle period determined in step 804 has arrived. If the communication idle period has arrived, the terminal receives a paging message from the ENB through communication with the ENB in step 807. In step 806, if the communication idle period has not arrived, the terminal waits for the communication idle period to arrive.

In step 808, the terminal maintains the communication with the ENB for the communication duration determined in step 804, and if the communication duration expires, the terminal enters the idle mode in step 809.

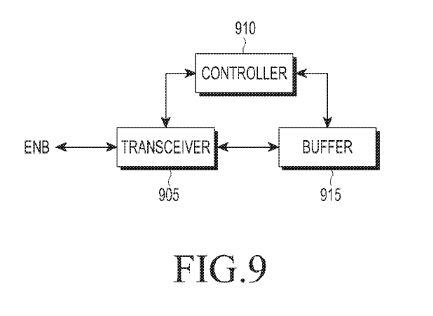

FIG. 9 is a block diagram illustrating a configuration of a terminal in a mobile communication system according to an embodiment of the present disclosure.

Referring to FIG. 9, a terminal includes a transceiver 905, a controller 910, and a buffer 915.

The transceiver 905 may receive system information from an ENB. The system information may include the information that the terminal requires in order to access the ENB, and may include a master information block (MIB), a scheduling block (SB) and a system information block (SIB). The MIB may allow the terminal to know or determine the physical configuration (e.g., the bandwidth) of the cell. Further, the SB may include transmission information of SIBs (e.g., scheduling information of SIBs). Further, the SIB is an aggregate of system information related to each other. For example, some SIBs may include only the information about the adjacent cell, and some SIBs may include only the information about the uplink wireless channel used by the terminal.

The controller 910 may determine the communication idle period and the communication duration based on the communication period-related information received through the transceiver 905. The controller 910 may identify whether the ENB supports communication depending on the communication idle period and the communication duration corresponding to the type of terminal, which is included in the communication period-related information. If the ENB supports communication depending on the communication idle period and the communication duration corresponding to the type of terminal, the controller 910 may determine the communication idle period and the communication duration corresponding to the terminal based on the information included in the communication period-related information. The controller 910 may determine the communication idle period and the communication duration by selecting an index corresponding to the type of terminal from the communication period-related information. If the communication period-related information included in the system information includes only the information indicating whether the ENB supports the communication scheme for allowing the terminal to determine a communication idle period and a communication duration depending on the type of terminal and perform communication depending on information about the determined communication idle period and communication duration, the controller 910 may determine the communication idle period and the communication duration, which is predefined in the controller 910, depending on the state of the terminal.

The controller 910 may control to transmit information about the determined communication idle period and communication duration to the ENB through the transceiver 905. The controller 910 may control to transmit the information about the determined communication idle period and communication duration to the ENB using an attach request message. The controller 910 may control to transmit the information about the determined communication idle period and communication duration to the ENB using a TAU request message. If data is generated during the communication idle period, the buffer 915 may store the generated data under control of the controller 910.

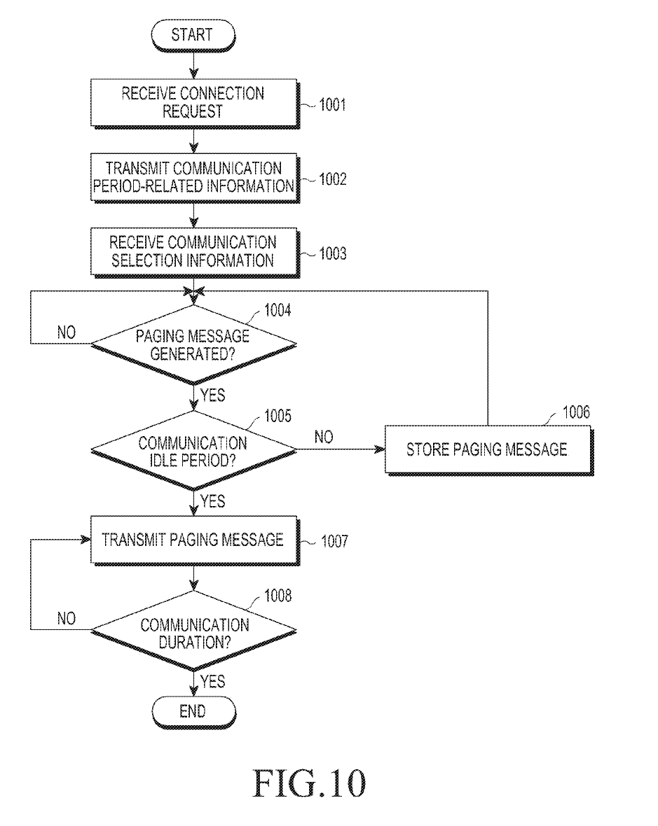

FIG. 10 is a flowchart illustrating a data transmission process of a base station according to an embodiment of the present disclosure.

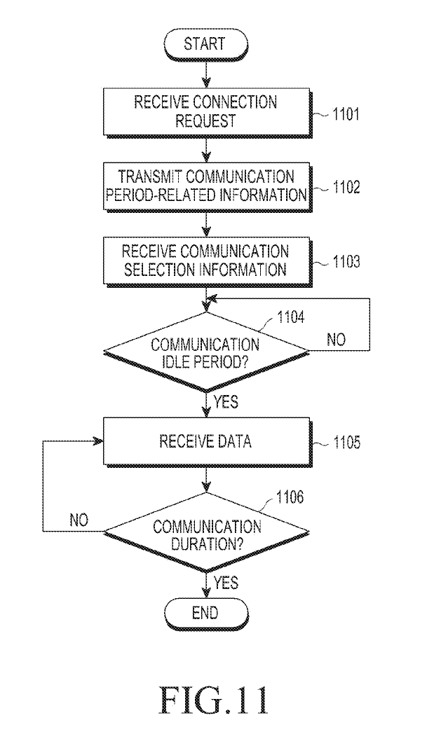

FIG. 11 is a flowchart illustrating a data reception process of a base station according to an embodiment of the present disclosure.

A data transmission/reception process of a base station according to various embodiments of the present disclosure will be described in detail below with reference to FIGS. 10 and 11.

Referring to FIG. 10, in step 1001, an ENB receives a connection request indicating that the communication connection is available as the terminal is powered on. For the connection request, a radio resource control (RRC) connection request message, which is one of the control messages of the RRC layer, may be used.

In step 1002, the ENB transmits system information to a terminal that has transmitted the connection request. The system information may include communication period-related information corresponding to the type of the terminal. The communication period-related information may include information indicating whether the ENB supports the communication scheme for allowing the terminal to determine a communication idle period and a communication duration depending on the type of the terminal and perform communication depending on information about at least one of the determined communication idle period and communication duration. Further, the communication period-related information may include the information pre-specifying information about at least one of the communication idle period and the communication duration corresponding to the type of the terminal.

In step 1003, the ENB receives, from the terminal, information about the communication idle period and the communication duration based on the communication period-related information included in the system information.

In step 1004, the ENB determines whether a paging message to be transmitted to the terminal has been generated. If the paging message has been generated, the ENB determines in step 1005 whether the communication idle period that was received from the terminal in step 1003 has arrived. If the communication idle period has not arrived, the ENB stores the generated paging message in step 1006, and if the communication idle period has arrived, the ENB transmits the generated or stored paging message to the terminal in step 1007.

In step 1008, the ENB maintains communication with the terminal for the communication duration that was received from the terminal in step 1003, and if the communication duration expires, the ENB may switch the communication with the terminal to the idle mode.

FIG. 11 is a flowchart illustrating a data reception process of a base station according to an embodiment of the present disclosure.

Referring to FIG. 11, in step 1101, the ENB receives a connection request that the communication connection is available as the terminal is powered on. For the connection request, a radio resource control (RRC) connection request message, which is one of the control messages of the RRC layer, may be used.

In step 1102, the ENB transmits system information to the terminal that has transmitted the connection request. The system information may include communication period-related information corresponding to the type of terminal. The communication period-related information may include information indicating whether the ENB supports the communication scheme for allowing the terminal to determine a communication idle period and a communication duration depending on the type of terminal and perform communication depending on the determined communication idle period and communication duration. Further, the communication period-related information may include the communication idle period and the communication duration corresponding to the type of terminal.

In step 1103, the ENB receives, from the terminal, information about the communication idle period and the communication duration based on the communication period-related information included in the system information.

In step 1104, the ENB determines whether the communication idle period that was received from the terminal in step 1103 has arrived, and if the communication idle period has arrived, the ENB receives generated data from the terminal through communication with the terminal in step 1105.

In step 1106, the ENB maintains communication with the terminal for the communication duration that was received from the terminal in step 1103, and if the communication duration expires, the ENB may switch the communication with the terminal to the idle mode. In step 1106, if the communication idle period has not arrived, the terminal waits for the communication idle period to arrive.

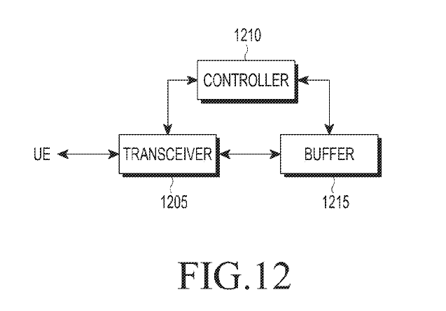

FIG. 12 is a block diagram illustrating a configuration of a base station in a mobile communication system according to an embodiment of the present disclosure.

Referring to FIG. 12, an ENB includes a transceiver 1205, a controller 1210, and a buffer 1215.

The transceiver 1205 may transmit system information to the terminal. The system information may include the information that the terminal requires in order to access the ENB, and may be configured with a master information block (MIB), a scheduling block (SB) and a system information block (SIB). The MIB may allow the terminal to know or determine the physical configuration (e.g., the bandwidth) of the cell. Further, the SB may include transmission information of SIBs (e.g., scheduling information of SIBs). Further, the SIB is an aggregate of system information related to each other. For example, some SIBs may include only the information about the adjacent cell, and some SIBs may include only the information about the uplink wireless channel used by the terminal. Further, the transceiver 1205 in the ENB may receive, from the terminal, information about the communication idle period and the communication duration determined based on the communication period-related information included in the system information.

The controller 1210 may control communication with the terminal depending on information about the determined communication idle period and communication duration, which is received from the terminal through the transceiver 1205. If a paging message to be transmitted to the terminal is generated, the controller 1210 may determine whether the determined communication idle period has arrived, and if the communication idle period has arrived, the controller 1210 may store the generated paging message in the buffer 1215. If the communication idle period has arrived, the controller 1210 may control to transmit the paging message stored in the buffer 1215 to the terminal.

If a paging message is generated during the communication idle period, the buffer 1215 may store the generated paging message under control of the controller 1210.

As is apparent from the foregoing description, various embodiments of the present disclosure provide a method for communication between a terminal and a base station and an apparatus therefor, to reduce the current consumption in a mobile communication system. Current consumption of the terminal is reduced while ensuring the connectivity, by setting a communication idle period corresponding to the type of terminal between the network and the terminal in the mobile communication system.

While the present disclosure has been shown and described with reference to certain embodiments thereof, it will be understood by those skilled in the art that various changes in form and details may be made therein without departing from the spirit and scope of the disclosure as defined by the appended claims and their equivalents.

What is claimed is:

1. A method for communicating with a base station, by a terminal, in a mobile communication system, the method comprising:
receiving, from the base station, communication period-related information corresponding to a type of the terminal;
determining at least one of a communication idle period and a communication duration based on the communication period-related information;
transmitting, to the base station, information indicating at least one of the communication idle period and the communication duration; and
communicating with the base station based on at least one of the communication idle period and the communication duration.

2. The method of claim 1, wherein the communication period-related information includes at least one of information indicating whether the base station supports communication depending on the communication idle period and the communication duration corresponding to the type of the terminal, and information specifying at least one of the communication idle period and the communication duration corresponding to the type of the terminal.

3. The method of claim 1, wherein the communication period-related information is received in system information from the base station.

4. The method of claim 1, wherein the information indicating the at least one of the determined communication idle period and communication duration is transmitted in at least one of an attach request message and a tracking area update request message.

5. The method of claim 1, wherein communicating with the base station comprises transmitting, to the base station, data, based on the at least one of the determined communication idle period and communication duration.

6. The method of claim 5, wherein communicating with the base station further comprises:
if the data is generated during the communication idle period, storing the generated data; and
if the communication idle period arrives, transmitting the data.

7. The method of claim 1, wherein communicating with the base station comprises receiving a paging message from the base station based on the at least one of the determined communication idle period and the communication duration.

8. The method of claim 7, wherein communicating with the base station further comprises, if the communication idle period arrives, receiving the paging message from the base station during the communication duration.

9. A terminal for communicating with a base station in a mobile communication system, the terminal comprising:
a transceiver configured to receive, from the base station, communication period-related information corresponding to a type of the terminal; and
a controller configured to determine at least one of a communication idle period and a communication duration based on the communication period-related information, and control communication with the base station based on the at least one of the communication idle period and the communication duration, wherein the transceiver transmits information indicating the at least one of the communication idle period and the communication duration to the base station, and communicates with the base station based on the at least one of the communication idle period and the communication duration.

10. The terminal of claim 9, further comprising a storage buffer configured to, if the data is generated during the communication idle period, store the generated data, wherein the controller is further configured to control an operation of, if the communication idle period arrives, transmitting the data stored in the storage buffer.

11. A method for communicating with a terminal, by a base station, in a mobile communication system, the method comprising:
transmitting, to the terminal, communication period-related information corresponding to a type of terminal;
receiving, from the terminal, information indicating at least one of a communication idle period and a communication duration, determined based on the communication period-related information; and
communicating with the terminal based on the at least one of the communication idle period and the communication duration.

12. The method of claim 11, wherein communicating with the terminal comprises receiving data from the terminal based on the at least one of the communication idle period and the communication duration.

13. The method of claim 12, wherein communicating with the terminal comprises, if the communication idle period arrives, receiving the data from the terminal during the communication duration.

14. The method of claim 11, wherein communicating with the terminal comprises transmitting, to the terminal, a paging message based on the at least one of the communication idle period and the communication duration.

15. The method of claim 14, wherein communicating with the terminal further comprises:
if the paging message is generated during the communication idle period, storing the generated paging message; and
if the communication idle period arrives, transmitting the paging message.

16. A base station for communicating with a terminal in a mobile communication system, the base station comprising:
a transceiver configured to transmit, to the terminal, communication period-related information corresponding to a type of the terminal, and receive, from the terminal, information indicating at least one of a communication idle period and a communication duration, determined based on the communication period-related information; and
a controller configured to control communication with the terminal based on the at least one of the communication idle period and the communication duration;
wherein the transceiver performs communication with the terminal based on the at least one of the communication idle period and the communication duration.

17. The base station of claim 15, further comprising a storage buffer configured to, if the paging message is generated during the communication idle period, store the generated paging message,
wherein the controller is further configured to control an operation of, if the communication idle period arrives, transmitting the paging message stored in the buffer.
